(19) United States
(12) Patent Application Publication
(10) Pub. No.: US 2016/0349967 A1
(43) Pub. Date: Dec. 1, 2016

(54) OFFLINE INVESTIGATION IN AN INDUSTRIAL AUTOMATION ENVIRONMENT

(71) Applicant: Rockwell Automation Technologies, Inc., Mayfield Heights, OH (US)

(72) Inventors: Matthew R. Ericsson, Lyndhurst, OH (US); Ashish Anand, Mayfield Heights, OH (US); Michael Ohlsen, Chesterland, OH (US); Kevin Peters, Aurora, OH (US); Milosz Scelina, Chorzow (PL); Wojciech Rycerz, Katowice (PL); Kyle Reissner, Hudson, OH (US)

(21) Appl. No.: 14/723,788

(22) Filed: May 28, 2015

(51) Int. Cl. G06F 3/0484; G06F 3/0482; G06F 3/0488; G06F 3/0481; H04L 29/06; G06F 3/06

(52) U.S. Cl. CPC G06F 3/04842; H04L 67/42; G06F 3/0604; G06F 3/0629; G06F 3/0673; G06F 3/0488; G06F 3/04817; G06F 3/0482

(57) ABSTRACT

Techniques to facilitate offline investigation for an application associated with an industrial automation environment are disclosed herein. In at least one implementation, application data is received for the application associated with the industrial automation environment transmitted from an application server over a communication network. A graphical user interface (GUI) is displayed on a display system of the computing system, wherein the GUI includes an offline pin option for a user to request offline storage of data. A selection of the offline pin option is received along with an identification of pinned data comprising at least a portion of the application data. The pinned data is stored in a local storage system of the computing system.

### TECHNICAL FIELD

Aspects of the disclosure are related to computing hardware and software technology.

### TECHNICAL BACKGROUND

Software applications that run on computing systems commonly provide some type of user client interface to present information to the user and receive user inputs. In a typical client-server architecture, an application running on a client computing system receives data transmitted from a server over a communication network for display to the user on the user client interface.

Industrial automation environments utilize machines during the industrial manufacturing process. These machines typically have various moving parts and other components that continually produce operational data over time, such as pressure, temperature, speed, and other metrics. Reviewing and monitoring this operational data is of high importance to those involved in operating an industrial enterprise.

In some cases, the operational data may be provided for display on a variety of systems and devices, such as notebook or tablet computers running standalone applications, web browsers, and the like, in order to present the information to the user. For example, a tablet computer could receive a constant stream of the operational data over a network and display this information dynamically, such as by providing live tiles, icons, charts, trends, and other graphical representations which continually receive updated operational data from external data sources, which are typically located in the industrial automation environment.

### OVERVIEW

Techniques to facilitate offline investigation for an application associated with an industrial automation environment are disclosed herein. In at least one implementation, application data is received for the application associated with the industrial automation environment transmitted from an application server over a communication network. A graphical user interface (GUI) is displayed on a display system of the computing system, wherein the GUI includes an offline pin option for a user to request offline storage of data. A selection of the offline pin option is received along with an identification of pinned data comprising at least a portion of the application data. The pinned data is stored in a local storage system of the computing system.

This Overview is provided to introduce a selection of concepts in a simplified form that are further described below in the Detailed Description. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a block diagram that illustrates an operation of a communication system in an exemplary implementation.

FIG. 2 is a flow diagram that illustrates an operation of a computing system in an exemplary implementation.

FIG. 3 is a block diagram that illustrates an operational scenario of a computing system in an exemplary implementation.

FIG. 4 is a block diagram that illustrates an operational scenario of a computing system in an exemplary implementation.

FIG. 5 is a block diagram that illustrates an operational scenario involving a computing system in an industrial automation environment in an exemplary implementation.

FIG. 6 is a block diagram that illustrates a computing system in an exemplary implementation.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Implementations disclosed herein provide for capturing industrial data locally on a mobile device which can later be used for offline investigation. In an industrial environment, investigation is primarily dependent on available plant-wide information, which is easily accessible when connected to a network of machines and other equipment. However, most industrial operations typically generate noise and interference that adversely effect wireless network conditions, resulting in varying levels of connectivity throughout a plant. When using a mobile device with little or no connection to a communication network, information sources may not be accessible, transmission errors are more likely, and user productivity suffers. The techniques disclosed herein facilitate taking snapshots or samples of industrial operation data and storing the data in local storage for later offline investigation.

In at least one implementation, a computing system receives data for an industrial application over a communication network. The user is given an option to pin data for offline storage. The user could specify several preferences, such as what data to pin, a past time period describing how far back to pin historical data, a future time period describing how long to store the pinned data locally, and any other data collection and storage preferences. In some implementations, data can be collected automatically in the background, which could occur on a predetermined schedule, periodically, in response to certain events, alarms, and other triggers, or from any other automatic programming. The user can then access and review the pinned data for investigation of industrial information even when the computing system is offline and not connected to a network or data source.

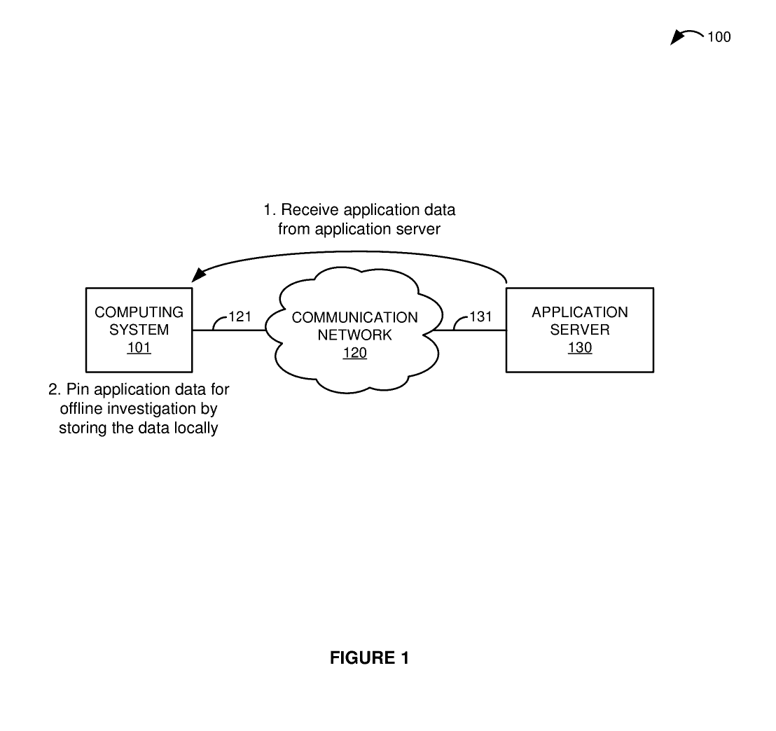

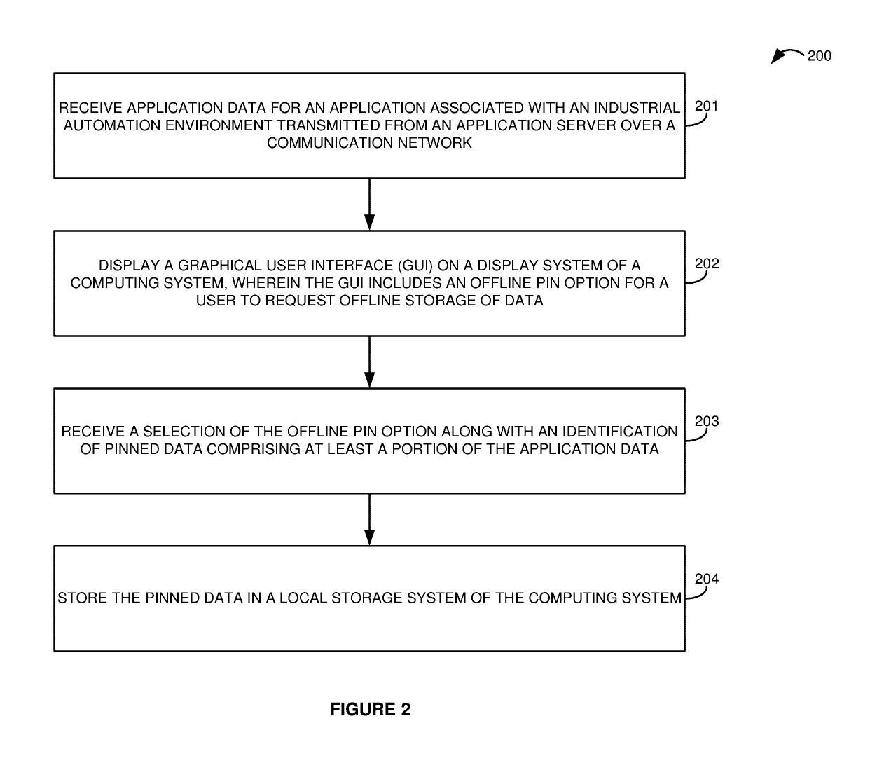

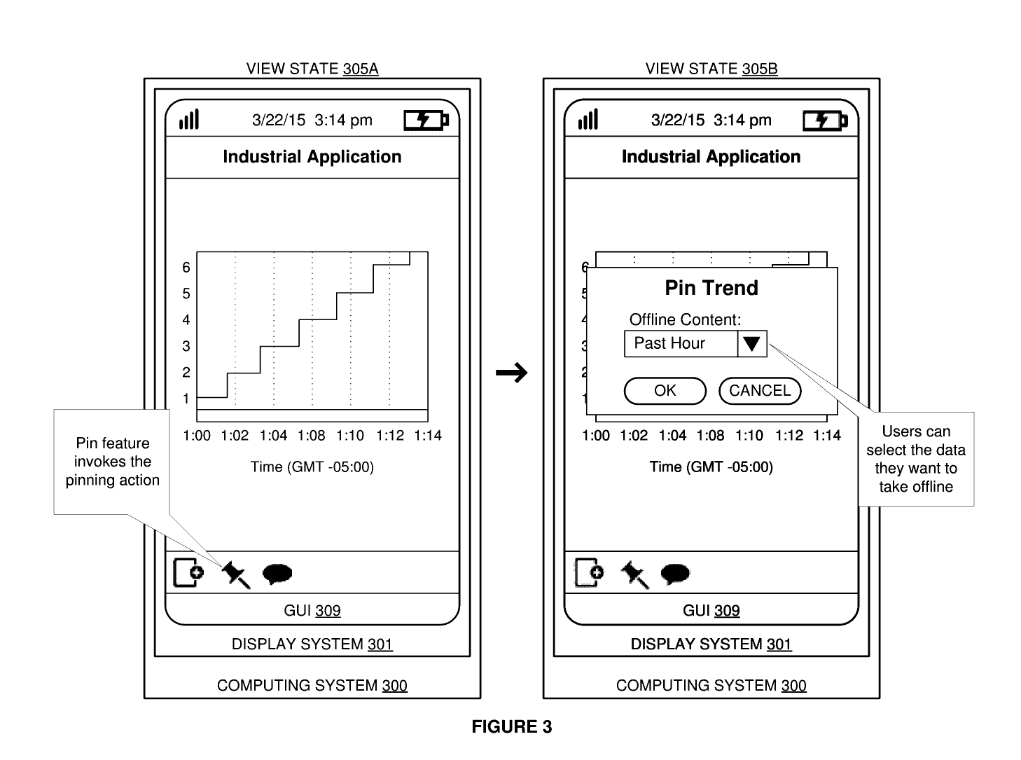

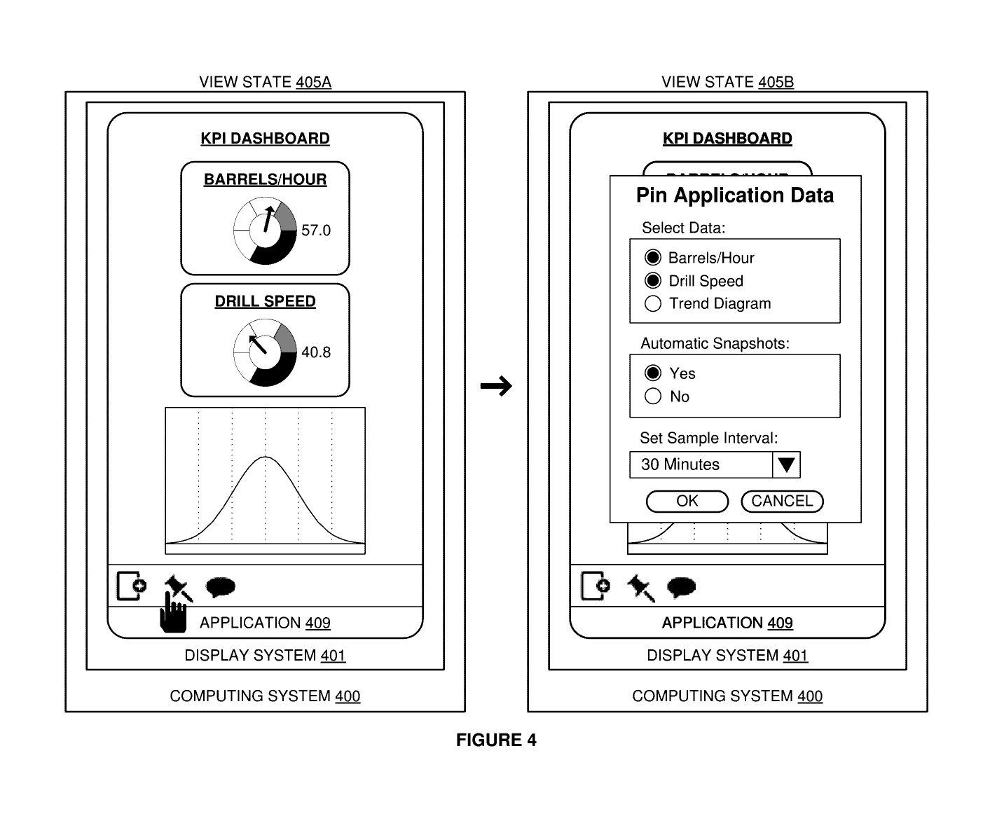

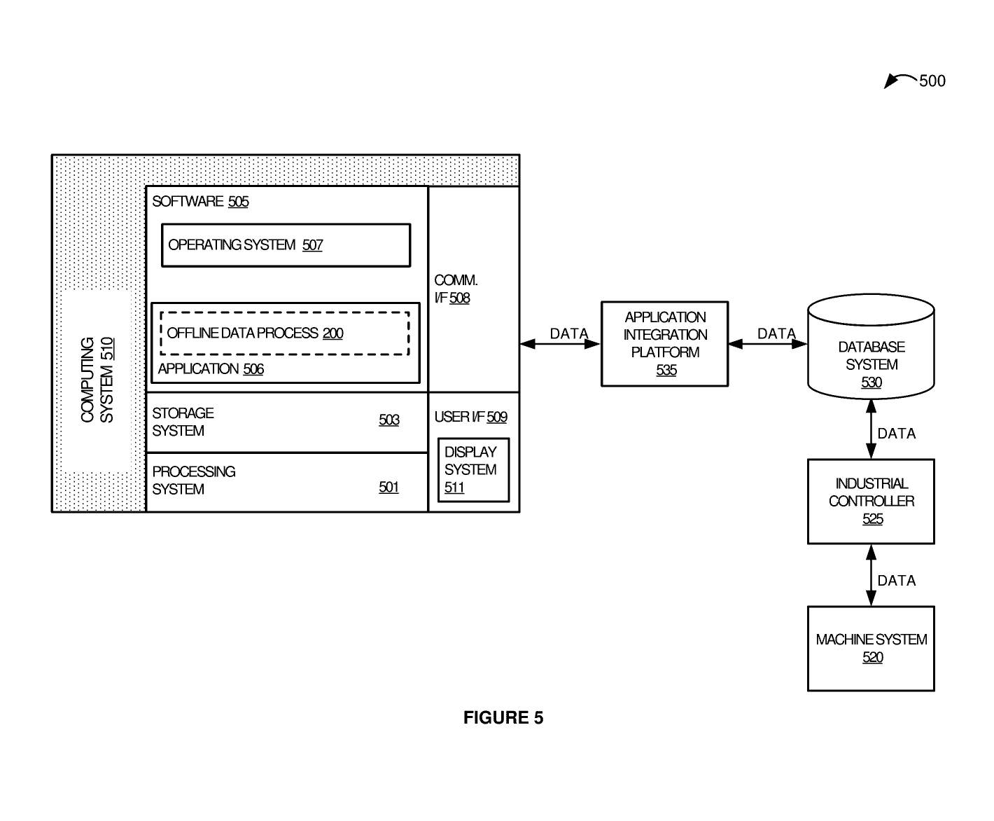

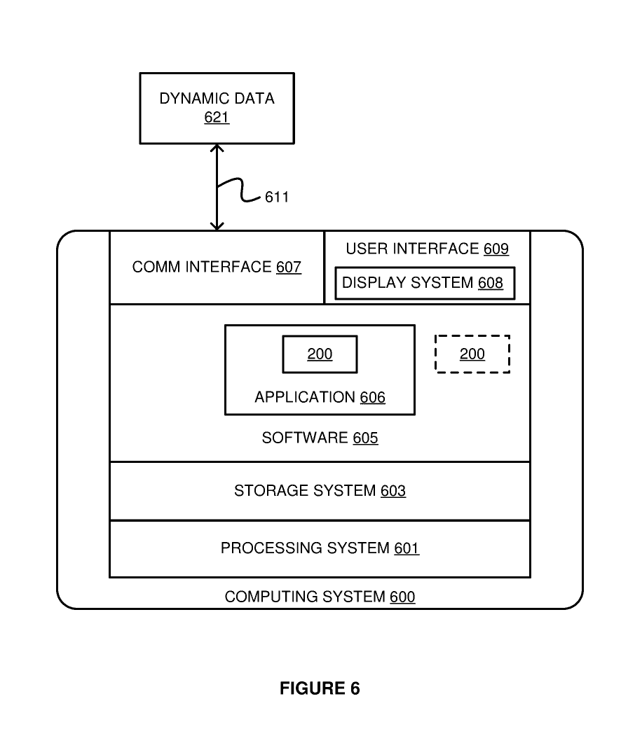

Referring now to the drawings, FIG. 1 illustrates a communication system and an operational scenario in which a user pins application data on a computing system for offline investigation. FIG. 2 illustrates an offline data process that may be performed by a computing system. FIG. 3 illustrates an operational scenario involving a computing system that pins a trend in an exemplary implementation, while FIG. 4 illustrates an operational scenario involving a computing system that pins application data in another exemplary implementation. FIG. 5 illustrates an exemplary industrial automation environment that includes a computing system that may be used to execute an offline data process, and FIG. 6 illustrates an exemplary computing system that may be used to perform any of the offline data processes and operational scenarios described herein.

Turning now to FIG. 1, an operational scenario of communication system 100 is illustrated in an exemplary implementation. Communication system 100 includes computing system 101, communication network 120, and application server 130. Computing system 101 and communication network 120 communicate over communication link 121, while communication network 120 and application server 130 are in communication over communication link 131. In some examples, communication network 120 could comprise an on-premise private network or private cloud accessible over a local network connection, a public cloud-based environment accessible over a wide area network such as the Internet, or any other deployment scheme, including combinations thereof.

An exemplary operation of communication system 100 is illustrated in FIG. 1, the order of which is designated by the numerals 1 and 2, but note that the steps could be performed in any order for any operation described herein. Initially, a user launches an application on computing system 101. The application instructs computing system 101 to connect to application server 130 and request data for the application. Computing system 101 then receives the application data over communication network 120 for presentation to the user.

In addition to the application data, the user is also presented with an option to pin the data for offline investigation. Pinning the application data effectively stores the data locally on computing system 101. Note that although the term “pin” is used herein, any other term could be used for the action of taking data offline and still be within the scope of this disclosure. When requesting to pin application data, the user can also select from various settings and preferences to specify what data is pinned, the manner in which it is stored, and other options. The user can retrieve the pinned data at a later time to conduct offline investigation of industrial information when computing system 101 is not in communication with application server 130. An exemplary operation of computing system 101 will now be described in greater detail with respect to FIG. 2.

FIG. 2 is a flow diagram that illustrates an operation 200 of a computing system in an exemplary implementation. The operation 200 shown in FIG. 2 may also be referred to as offline data process 200 herein. The steps of the operation are indicated below parenthetically. The following discussion of operation 200 will proceed with reference to computing system 101 and application server 130 of FIG. 1 in order to illustrate its operations, but note that the details provided in FIG. 1 are merely exemplary and not intended to limit the scope of process 200 to the specific implementation shown in FIG. 1.

Operation 200 may be employed to operate a computing system to facilitate offline investigation for an application associated with an industrial automation environment. However, operation 200 could also be employed by a computing system to facilitate offline investigation for any software application irrespective of its purpose or functionality, including a website or webpages provided by a server for viewing in a web browser, mobile applications for execution on a mobile device, editing and design tools, media players, simulation software, or any other application.

As shown in the operational flow of process 200, computing system 101 receives application data for an application associated with an industrial automation environment transmitted from application server 130 over communication network 120 (201). The application data is typically received in response to a user request for the data, but the data could also be requested by the application and/or transmitted by application server 130 automatically on a scheduled or periodic basis, or in response to alarms and other events to notify the user of potential problems. The application data could comprise any data for an application associated with an industrial automation environment. In some examples, the application data could comprise operational data, machine data, screen graphics data, screen captures, video data, tag data, alarms, drive configurations, key performance indicators (KPIs), charts, trends, and other graphical content, simulation data, or any other data associated with an industrial automation environment, including combinations thereof. Application server 130 typically collects and retrieves the application data for the application and transfers the data to computing system 101, but note that the application data could be received from various different systems which may be in geographically diverse locations. In some examples, application server 130 could comprise a system located on-premise and accessible over a local network connection, or running in a cloud-based environment accessed over a wide area network such as the Internet, or any other deployment scheme, including combinations thereof. In some implementations, application server 130 or at least its functionality could be included within computing system 101, so that establishing a network connection to reach server 130 would be unnecessary. Other system and network architectures are possible and within the scope of this disclosure.

Computing system 101 displays a graphical user interface (GUI) on a display system of computing system 101, wherein the GUI includes an offline pin option for a user to request offline storage of data (202). The GUI is typically associated with the application executing on computing system 101, and provides the user with an interface to view and interact with graphical content and other data displayed by computing system 101. The offline pin option displayed on the GUI allows a user to request offline storage of data. The offline pin option may function in several ways. In some implementations, the offline pin option provides a mechanism to store or “pin” some or all of the application data presently displayed by computing system 101 when the offline pin option is selected. In other examples, the user could also specify the data for pinning, or the data could be predetermined and pinned automatically, or identified in some other way.

The user can set various options and settings that dictate the behavior of the offline pin option, and these settings can be preconfigured or configured on-the-fly after selecting the offline pin option. Preconfigured settings can apply to individual data elements or could apply to collections of elements, such as groups of data elements that appear on the same display, or are associated with the same manufacturing plant, batch, production line, machine, and the like, or are categorized under the same type of data, or any other data classification. Some examples of settings that could apply to the offline pin option include identifying what data to store, specifying time periods for when to capture historical data, how far into the future to capture new data, and how long to store the pinned data locally, and any other data collection and storage preferences. For example, a user could preconfigure settings to store a screen capture of the display system every thirty minutes and to not delete the screen captures for at least one week. Various restrictions may also be placed on individual users or groups of users to limit some functionality of the offline pin option, such as preventing some users from pinning specific data elements or data types, limiting the amount of time the pinned data may be stored locally, limiting the number of times a user can access the pinned data, limiting the use of the pinned data, and any other restrictions.

Computing system 101 receives a selection of the offline pin option along with an identification of pinned data comprising at least a portion of the application data (203). The user typically selects the offline pin option through user input that could be provided by a variety of different techniques, such as providing touch gestures on a touch screen, entering text commands with a keyboard, clicking a mouse pointer, speaking a voice command, or any other user input mechanism. In some examples, the selection of the offline pin option could comprise instructions to pin application data immediately, or to configure computing system 101 to automatically pin data during future time periods. In at least one implementation, the selection of the offline pin option along with the identification of the pinned data could include a request to periodically store updates to the pinned data automatically. For example, application server 130 could be configured to automatically synchronize the pinned data periodically by pushing the content to computing system 101 in the background, which could occur whenever the pinned data is updated or changed. The selection of the offline pin option could also comprise any of the data collection options, storage preferences, and any other settings described herein for pinning data. In this example, the user identifies at least a portion of the application data for computing system 101 to store locally as pinned data. In some implementations, the identification of the pinned data could include selection of a time period associated with the pinned data, which could specify how far back in time the pinned data extends, how long to store the pinned data locally, or any other time period associated with the pinned data. As discussed above, other settings and preferences may be included in the selection of the offline pin option and are within the scope of this disclosure.

Computing system 101 stores the pinned data in a local storage system of computing system 101 (204). Computing system 101 effectively caches the data locally to ensure its availability even when computing system 101 has little or no network connectivity or is otherwise not in communication with application server 130. Accordingly, computing system 101 may, responsive to a user request to view the pinned data when computing system 101 is not in communication with application server 130, retrieve the pinned data from the local storage system and display the pinned data on the display system. In some examples, computing system 101 could display a list of pinned data items from which the user may select to view, delete, and otherwise manage the pinned data. The list of pinned data items could be maintained at computing system 101, application server 130, or some other computing system, and could be stored on a per-user basis, per-device, or any other basis. In some implementations, storing the pinned data in the local storage system could comprise periodically storing the pinned data automatically in the local storage system. In at least one implementation, computing system 101 could also be instructed to store the pinned data in the local storage system for a time period, such as in response to a storage preference provided by the user, or based on term limits for offline data storage that apply universally to all data and/or users or that vary between different data types, users, worker roles, and other factors. After expiration of the time period, computing system 101 would automatically delete the pinned data from the local storage system in some implementations.

Advantageously, computing system 101 can pin application data received from application server 130 by storing the data locally for later offline investigation. A user can then access the pinned data stored locally on computing system 101 regardless of the level of network connectivity. By utilizing this data pinning feature, users can still access plant data even where wireless networking coverage is inconsistent or not fully deployed. Offline data pinning also facilitates deploying network infrastructure in stages, where value is realized at every step of the overall deployment in an enterprise, thereby accelerating time to value. An example of a graphical user interface provided by an application that illustrates one possible implementation of the techniques disclosed herein will now be discussed with respect to FIG. 3.

FIG. 3 is a block diagram that illustrates an operational scenario of computing system 300 in an exemplary implementation. Computing system 300 includes display system 301 which displays graphical user interface (GUI) 309 of an application. In this example, display system 301 comprises a touch screen that displays GUI 309 for the user to interact with and accepts input commands from the user via the user's touches on the surface of the touch screen. In FIG. 3, two different view states are shown displayed on display system 301, labeled 305A and 305B. The different view states show the changes that occur to GUI 309 as the user makes selections and interacts with GUI 309 and its associated application.

In view state 305A, the user is presented with a trend diagram on GUI 309 that illustrates a number of widgets produced over time. The application typically directs computing system 300 to receive this trend data from an application server over a communication network for display on GUI 309. Along the bottom of GUI 309 are several options and settings associated with the application. One option, which appears as a pushpin icon on GUI 309, provides the data pinning feature. When selected by the user, the pinning action for offline data storage is invoked. Note that the pushpin icon appearing on GUI 309 is merely exemplary, and many other terms, icons, or actions could be used to enable users to take data offline in other examples.

View state 305B illustrates an exemplary dialog box that may appear in response to a user selecting the pin feature shown in view state 305A. The dialog box, labeled “Pin Trend”, enables the user to pin the trend diagram and/or its underlying data values to a local storage system of computing system 300. In the dialog box, the user is presented with a dropdown menu to select from various time periods to identify the data range that the user desires to take offline. In this example, the user selects the offline content as the past hour of trend data. When the user selects “OK”, the application stores the selected data in a local storage system of computing system 300 for later retrieval, thereby facilitating offline investigation of this industrial information. An exemplary implementation of another data pinning process will now be discussed with respect to FIG. 4.

FIG. 4 is a block diagram that illustrates an operational scenario of computing system 400 in an exemplary implementation. Computing system 400 executes application 409 which generates graphical content for display on display system 401. In this example, application 409 comprises an industrial automation mobile application for use on a mobile device such as a smartphone, tablet, or laptop. Application 409 comprises a human-machine interface (HMI) application for an oil extraction industry, which typically interfaces with machines, controllers, and other systems in an industrial automation environment. As illustrated in view state 405A, application 409 displays a key performance indicator (KPI) dashboard related to the extraction of crude oil, where gauges indicating barrels per hour and drill speed are displayed along with a trend diagram. A data pinning option represented by a pushpin icon is also displayed at the bottom of application 409 among other options. In this example, the user selects the data pinning option by touching the pushpin icon, as represented by the small hand icon appearing in view state 405A.

View state 405B illustrates an exemplary dialog box that may appear in response to a user selecting the pin feature shown in view state 405A. The dialog box, labeled “Pin Application Data”, enables the user to pin data to a local storage system of computing system 400. In the dialog box, the user is presented with radio buttons and a dropdown menu for selecting among various settings for the data pinning option. In the “Select Data” section, the user can select which data items appearing on the KPI dashboard shown in view state 405A the user desires to pin. In this example, the user has selected the radio buttons for the “Barrels/Hour” and “Drill Speed” KPIs. The next section, labeled “Automatic Snapshots”, allows a user to specify whether snapshots of the data should be automatically captured and stored locally in computing system 400. In this case, the user has selected the radio button labeled “Yes”, which indicates to application 409 that the user desires automatic snapshots of the selected data. The third section appearing in the dialog box, labeled “Set Sample Interval”, enables the user to specify the sample frequency for the automatic data snapshots. In this case, the user has selected a sample interval of thirty minutes.

When the user selects “OK”, application 409 stores the selected data in a local storage system of computing system 400 in accordance with the above settings for later offline retrieval. In this case, application 409 would direct computing system 400 to automatically store snapshots of the “Barrels/Hour” and “Drill Speed” KPIs periodically by sampling these data values every thirty minutes. In this manner, the user can conduct offline investigation into the performance of the drilling operations by referring to the KPI data that is automatically stored locally within computing system 400 on a periodic basis. This technique of pinning data for later offline investigation empowers industrial users to analyze important plant data and continue their work, even in varying levels of network connectivity.

Referring back to FIG. 1, computing system 101 comprises a processing system and communication transceiver. Computing system 101 may also include other components such as a user interface, data storage system, and power supply. Computing system 101 may reside in a single device or may be distributed across multiple devices. Examples of computing system 101 include mobile computing devices, such as cell phones, tablet computers, laptop computers, notebook computers, and gaming devices, as well as any other type of mobile computing devices and any combination or variation thereof. Examples of computing system 101 also include desktop computers, server computers, and virtual machines, as well as any other type of computing system, variation, or combination thereof. In some implementations, computing system 101 could comprise a mobile device capable of operating in a server-like fashion which, among other uses, could be utilized in a wireless mesh network.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, asynchronous transfer mode (ATM) networks, packet networks, wireless mesh networks (WMN), local area networks (LAN), metropolitan area networks (MAN), wide area networks (WAN), or other network topologies, equipment, or systems—including combinations thereof. Communication network 120 may be configured to communicate over metallic, wireless, or optical links. Communication network 120 may be configured to use time-division multiplexing (TDM), Internet Protocol (IP), Ethernet, optical networking, wireless protocols, communication signaling, peer-to-peer networking over Bluetooth, Bluetooth low energy, Wi-Fi Direct, near field communication (NFC), or some other communication format, including combinations thereof. In some examples, communication network 120 includes further access nodes and associated equipment for providing communication services to several computer systems across a large geographic region.

Application server 130 may be representative of any computing apparatus, system, or systems on which the techniques disclosed herein or variations thereof may be suitably implemented. Application server 130 comprises a processing system and communication transceiver. Application server 130 may also include other components such as a router, server, data storage system, and power supply. Application server 130 may reside in a single device or may be distributed across multiple devices. Application server 130 may be a discrete system or may be integrated within other systems, including other systems within communication system 100 or an automation control system. Some examples of application server 130 include desktop computers, server computers, cloud computing platforms, and virtual machines, as well as any other type of computing system, variation, or combination thereof. In some examples, application server 130 could comprise a programmable logic controller (PLC), programmable automation controller (PAC), network switch, router, switching system, packet gateway, authentication, authorization, and accounting (AAA) server, billing system, network gateway system, Internet access node, data server, database system, service node, firewall, or some other communication system, including combinations thereof. In some implementations, a PLC, PAC, and/or specific modules within the PLC rack could provide some or all of the functionality described herein for application server 130.

Communication links 121 and 131 use metal, air, space, optical fiber such as glass or plastic, or some other material as the transport medium—including combinations thereof. Communication links 121 and 131 could use various communication protocols, such as TDM, IP, Ethernet, telephony, optical networking, hybrid fiber coax (HFC), communication signaling, wireless protocols, or some other communication format, including combinations thereof. Communication links 121 and 131 could be direct links or may include intermediate networks, systems, or devices.

Turning now to FIG. 5, a block diagram that illustrates an industrial automation environment 500 in an exemplary implementation is shown. Industrial automation environment 500 provides an example of an industrial automation environment that may be utilized to implement the offline data processes disclosed herein, but other environments could also be used. Industrial automation environment 500 includes computing system 510, machine system 520, industrial controller 525, database system 530, and application integration platform 535. Machine system 520 and controller 525 are in communication over a communication link, controller 525 and database system 530 communicate over a communication link, database system 530 and application integration platform 535 communicate over a communication link, and application integration platform 535 and computing system 510 are in communication over a communication link. Note that there would typically be many more machine systems in most industrial automation environments, but the number of machine systems shown in FIG. 5 has been restricted for clarity.

Industrial automation environment 500 comprises an automobile manufacturing factory, food processing plant, oil drilling operation, microprocessor fabrication facility, or some other type of industrial enterprise. Machine system 520 could comprise a sensor, drive, pump, filter, drill, motor, robot, fabrication machinery, mill, printer, or any other industrial automation equipment, including their associated control systems. A control system comprises, for example, industrial controller 525, which could include automation controllers, programmable logic controllers (PLCs), programmable automation controllers (PACs), or any other controllers used in automation control. Additionally, machine system 520 could comprise other industrial equipment, such as a brew kettle in a brewery, a reserve of coal or other resources, or any other element that may reside in an industrial automation environment 500.

Machine system 520 continually produces operational data over time. The operational data indicates the current status of machine system 520, such as parameters, pressure, temperature, speed, energy usage, operational equipment effectiveness (OEE), mean time between failure (MTBF), mean time to repair (MTTR), voltage, throughput volumes, times, tank levels, or any other performance status metrics. The operational data may comprise dynamic charts or trends, real-time video, or some other graphical content. Machine system 520 and/or controller 525 is capable of transferring the operational data over a communication link to database system 530, application integration platform 535, and computing system 510, typically via a communication network. Database system 530 could comprise a disk, tape, integrated circuit, server, or some other memory device. Database system 530 may reside in a single device or may be distributed among multiple memory devices.

Application integration platform 535 comprises a processing system and a communication transceiver. Application integration platform 535 may also include other components such as a router, server, data storage system, and power supply. Application integration platform 535 provides an example of application server 130, although server 130 could use alterative configurations. Application integration platform 535 may reside in a single device or may be distributed across multiple devices. Application integration platform 535 may be a discrete system or may be integrated within other systems—including other systems within industrial automation environment 500. In some examples, application integration platform 535 could comprise a FactoryTalk® VantagePoint server system provided by Rockwell Automation, Inc.

The communication links over which data is exchanged between machine system 520, industrial controller 525, database system 530, application integration platform 535, and communication interface 508 of computing system 510 could use metal, air, space, optical fiber such as glass or plastic, or some other material as the transport medium—including combinations thereof. The communication links could comprise multiple network elements such as routers, gateways, telecommunication switches, servers, processing systems, or other communication equipment and systems for providing communication and data services. These communication links could use various communication protocols, such as TDM, IP, Ethernet, telephony, optical networking, packet networks, wireless mesh networks (WMN), local area networks (LAN), metropolitan area networks (MAN), wide area networks (WAN), hybrid fiber coax (HFC), communication signaling, wireless protocols, communication signaling, peer-to-peer networking over Bluetooth, Bluetooth low energy, Wi-Fi Direct, near field communication (NFC), or some other communication format, including combinations thereof. The communication links could be direct links or may include intermediate networks, systems, or devices.

Computing system 510 may be representative of any computing apparatus, system, or systems on which the offline data processes disclosed herein or variations thereof may be suitably implemented. Computing system 510 provides an example of a computing system that could be used as a either a server or a client device in some implementations, although such devices could have alternative configurations. Examples of computing system 510 include mobile computing devices, such as cell phones, tablet computers, laptop computers, notebook computers, and gaming devices, as well as any other type of mobile computing devices and any combination or variation thereof. Examples of computing system 510 also include desktop computers, server computers, and virtual machines, as well as any other type of computing system, variation, or combination thereof. In some implementations, computing system 510 could comprise a mobile device capable of operating in a server-like fashion which, among other uses, could be utilized in a wireless mesh network.

Computing system 510 includes processing system 501, storage system 503, software 505, communication interface 508, and user interface 509. Processing system 501 is operatively coupled with storage system 503, communication interface 508, and user interface 509. Processing system 501 loads and executes software 505 from storage system 503. Software 505 includes application 506 and operating system 507. Application 506 may include offline data process 200 in some examples. When executed by computing system 510 in general, and processing system 501 in particular, software 505 directs computing system 510 to operate as described herein for offline data process 200 or variations thereof. In this example, user interface 509 includes display system 511, which itself may be part of a touch screen that also accepts user inputs via touches on its surface. Computing system 510 may optionally include additional devices, features, or functionality not discussed here for purposes of brevity.

Turning now to FIG. 6, a block diagram is shown that illustrates computing system 600 in an exemplary implementation. Computing system 600 provides an example of computing systems 101, 300 and 400, or any computing system that may be used to execute offline data process 200 or variations thereof, although such systems could use alternative configurations. Computing system 600 includes processing system 601, storage system 603, software 605, communication interface 607, and user interface 609. User interface 609 comprises display system 608. Software 605 includes application 606 which itself includes offline data process 200. Offline data process 200 may optionally be implemented separately from application 606.

Computing system 600 may be representative of any computing apparatus, system, or systems on which application 606 and offline data process 200 or variations thereof may be suitably implemented. Examples of computing system 600 include mobile computing devices, such as cell phones, tablet computers, laptop computers, notebook computers, and gaming devices, as well as any other type of mobile computing devices and any combination or variation thereof. Note that the features and functionality of computing system 600 may apply as well to desktop computers, server computers, and virtual machines, as well as any other type of computing system, variation, or combination thereof.

Computing system 600 includes processing system 601, storage system 603, software 605, communication interface 607, and user interface 609. Processing system 601 is operatively coupled with storage system 603, communication interface 607, and user interface 609. Processing system 601 loads and executes software 605 from storage system 603. When executed by computing system 600 in general, and processing system 601 in particular, software 605 directs computing system 600 to operate as described herein for offline data process 200 or variations thereof. Computing system 600 may optionally include additional devices, features, or functionality not discussed herein for purposes of brevity.

Referring still to FIG. 6, processing system 601 may comprise a microprocessor and other circuitry that retrieves and executes software 605 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device, combinations, or variations thereof.

Storage system 603 may comprise any computer readable media or storage media readable by processing system 601 and capable of storing software 605. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

In operation, in conjunction with user interface 609, processing system 601 loads and executes portions of software 605, such as offline data process 200, to render a graphical user interface for application 606 for display by display system 608 of user interface 609. Software 605 may be implemented in program instructions and among other functions may, when executed by computing system 600 in general or processing system 601 in particular, direct computing system 600 or processing system 601 to receive application data for application 606 associated with an industrial automation environment transmitted from an application server over a communication network. Software 605 may further direct computing system 600 or processing system 601 to display a graphical user interface (GUI) on display system 608 of computing system 600, wherein the GUI includes an offline pin option for a user to request offline storage of data. In addition, software 605 directs computing system 600 or processing system 601 to receive a selection of the offline pin option along with an identification of pinned data comprising at least a portion of the application data. Finally, software 605 may direct computing system 600 or processing system 601 to store the pinned data in a local storage system 603 of computing system 600.

Software 605 may include additional processes, programs, or components, such as operating system software or other application software. Examples of operating systems include Windows®, iOS®, and Android®, as well as any other suitable operating system. Software 605 may also comprise firmware or some other form of machine-readable processing instructions executable by processing system 601.

In general, software 605 may, when loaded into processing system 601 and executed, transform computing system 600 overall from a general-purpose computing system into a special-purpose computing system customized to facilitate offline data pinning for an application as described herein for each implementation. For example, encoding software 605 on storage system 603 may transform the physical structure of storage system 603. The specific transformation of the physical structure may depend on various factors in different implementations of this description. Examples of such factors may include, but are not limited to the technology used to implement the storage media of storage system 603 and whether the computer-readable storage media are characterized as primary or secondary storage.

In some examples, if the computer-readable storage media are implemented as semiconductor-based memory, software 605 may transform the physical state of the semiconductor memory when the program is encoded therein. For example, software 605 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 600 is generally intended to represent a computing system with which software 605 is deployed and executed in order to implement application 606 and/or offline data process 200 (and variations thereof). However, computing system 600 may also represent any computing system on which software 605 may be staged and from where software 605 may be distributed, transported, downloaded, or otherwise provided to yet another computing system for deployment and execution, or yet additional distribution. For example, computing system 600 could be configured to deploy software 605 over the internet to one or more client computing systems for execution thereon, such as in a cloud-based deployment scenario.

Communication interface 607 may include communication connections and devices that allow for communication between computing system 600 and other computing systems (not shown) or services, over a communication network 611 or collection of networks. In some implementations, communication interface 607 receives dynamic data 621 over communication network 611. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 609 may include a voice input device, a touch input device for receiving a gesture from a user, a motion input device for detecting non-touch gestures and other motions by a user, and other comparable input devices and associated processing elements capable of receiving user input from a user. Output devices such as display system 608, speakers, haptic devices, and other types of output devices may also be included in user interface 609. The aforementioned user input devices are well known in the art and need not be discussed at length here. User interface 609 may also include associated user interface software executable by processing system 601 in support of the various user input and output devices discussed above. Separately or in conjunction with each other and other hardware and software elements, the user interface software and devices may provide a graphical user interface, a natural user interface, or any other kind of user interface.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. One or more computer-readable storage media having program instructions stored thereon to facilitate offline investigation for an application associated with an industrial automation environment, wherein the program instructions, when executed by a computing system, direct the computing system to at least:
receive application data for the application associated with the industrial automation environment transmitted from an application server over a communication network;
display a graphical user interface (GUI) on a display system of the computing system, wherein the GUI includes an offline pin option for a user to request offline storage of data;
receive a selection of the offline pin option along with an identification of pinned data comprising at least a portion of the application data; and
store the pinned data in a local storage system of the computing system.

2. The one or more computer-readable storage media of claim 1 wherein the program instructions further direct the computing system to, responsive to a user request to view the pinned data when the computing system is not in communication with the application server, retrieve the pinned data from the local storage system and display the pinned data on the display system.

3. The one or more computer-readable storage media of claim 1 wherein the selection of the offline pin option along with the identification of the pinned data includes a request to periodically store updates to the pinned data automatically.

4. The one or more computer-readable storage media of claim 1 wherein the program instructions direct the computing system to store the pinned data in the local storage system by directing the computing system to periodically store the pinned data automatically in the local storage system.

5. The one or more computer-readable storage media of claim 1 wherein the program instructions direct the computing system to store the pinned data in the local storage system by directing the computing system to store the pinned data in the local storage system for a time period.

6. The one or more computer-readable storage media of claim 5 wherein the program instructions further direct the computing system to automatically delete the pinned data from the local storage system after expiration of the time period.

7. The one or more computer-readable storage media of claim 1 wherein the identification of the pinned data includes selection of a time period associated with the pinned data.

8. A method to facilitate offline investigation for an application associated with an industrial automation environment, the method comprising:
receiving application data for the application associated with the industrial automation environment transmitted from an application server over a communication network;
displaying a graphical user interface (GUI) on a display system of a computing system, wherein the GUI includes an offline pin option for a user to request offline storage of data;
receiving a selection of the offline pin option along with an identification of pinned data comprising at least a portion of the application data; and
storing the pinned data in a local storage system of the computing system.

9. The method of claim 8 further comprising, responsive to a user request to view the pinned data when the computing system is not in communication with the application server, retrieving the pinned data from the local storage system and displaying the pinned data on the display system.

10. The method of claim 8 wherein the selection of the offline pin option along with the identification of the pinned data includes a request to periodically store updates to the pinned data automatically.

11. The method of claim 8 wherein storing the pinned data in the local storage system comprises periodically storing the pinned data automatically in the local storage system.

12. The method of claim 8 wherein storing the pinned data in the local storage system comprises storing the pinned data in the local storage system for a time period.

13. The method of claim 13 further comprising automatically deleting the pinned data from the local storage system after expiration of the time period.

14. The method of claim 8 wherein the identification of the pinned data includes selection of a time period associated with the pinned data.

15. An apparatus to facilitate offline investigation for an application associated with an industrial automation environment, the apparatus comprising:
one or more computer-readable storage media; and
program instructions stored on the one or more computer-readable storage media that, when executed by a processing system, direct the processing system to at least:
receive application data for the application associated with the industrial automation environment transmitted from an application server over a communication network;
display a graphical user interface (GUI) on a display system, wherein the GUI includes an offline pin option for a user to request offline storage of data;
receive a selection of the offline pin option along with an identification of pinned data comprising at least a portion of the application data; and
store the pinned data in a local storage system.

16. The apparatus of claim 15 wherein the program instructions further direct the processing system to, responsive to a user request to view the pinned data when the application is not in communication with the application server over the communication network, retrieve the pinned data from the local storage system and display the pinned data on the display system.

17. The apparatus of claim 15 wherein the selection of the offline pin option along with the identification of the pinned data includes a request to periodically store updates to the pinned data automatically.

18. The apparatus of claim 15 wherein the program instructions direct the processing system to store the pinned data in the local storage system by directing the processing system to periodically store the pinned data automatically in the local storage system.

19. The apparatus of claim 15 wherein the program instructions direct the processing system to store the pinned data in the local storage system by directing the processing system to store the pinned data in the local storage system for a time period.

20. The apparatus of claim 19 wherein the program instructions further direct the processing system to automatically delete the pinned data from the local storage system after expiration of the time period.
